(19) United States
(12) Patent Application Publication
(10) Pub. No.: US 2006/0032136 A1
(43) Pub. Date: Feb. 16, 2006

(54) Automatically watered flowerpot

(76) Inventor: Chung-Yang Chou, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/912,335

(22) Filed: Aug. 6, 2004

(51) Int. Cl. A01G 25/00

(52) U.S. Cl. 47/80

(57) ABSTRACT

An automatically watered flowerpot comprises a vessel of the flowerpot with an upward opening, and a stop board or an interior basin set in the vessel to form a first receiving room and a second receiving room; potted plants are put in-the first receiving room and water is stored in the second receiving room. At least one water intake pipe and one water spraying pipe are set inside the vessel; the water intake pipe stretches from the first receiving room to the second receiving room, and water can be filled into the second receiving room. A water drawing machine is connected to the water spraying pipe in the second receiving room and controlled by the controller to draw water for a fixed amount at a fixed time. Water is sprayed to the first receiving room by the water spraying pipe to prevent the plants from drying up.

### BACKGROUND OF THE INVENTION

1. Field of the Invention

The present invention is related to an automatically watered flowerpot, especially to a flowerpot using a control circuit to preset a time for watering.

2. Description of Related Art

Now, planting pot plants is very common in interior designs. However, people in the society of industry and commerce are too busy to take care of the plants, particularly when they go on a travel of business. The plants are always dried up owing to the above-mentioned reason.

Therefore, a prior art flowerpot usually connects to a water drawing motor outside, and the water drawing motor is set in a reservoir and sprays water on the plants with fixed amount of water at a fixed time everyday. Thus, plants are not dried up easily.

However, the appearance of the prior art flowerpot does not match with the aesthetic perception for interior designs. Furthermore, no warning functions for overdrawing water in the reservoir, and the motor is thus burned easily.

By considering the inconvenience of connecting a motor outside the flowerpot, the present invention provides an automatically watered flowerpot for improving the above-mentioned drawbacks and increase lives of the plants.

### SUMMARY OF THE INVENTION

The object of the present invention is to provide an automatically watered flowerpot. Two receiving rooms are set inside the automatically watered flowerpot; the upper receiving room is designed for planting pot plants and the lower receiving room is designed for storing water. Besides, a watering device for watering at a fixed time is designed for the invention and the drawbacks like too many water pipes of the water drawing motor are thus solved. The pot plants can be watered by the above-mentioned designs and is not dried up easily; furthermore, aesthetic perception of interior designs can be improved

To achieve the above-mentioned object, the present invention provides an automatically watered flowerpot, which comprises a vessel of the flowerpot with an upward opening and a stop board or an inner pot set in the vessel of the flowerpot to form a first receiving room and a second receiving room. Moreover, potted plants are planted in the first receiving room and the water is stored in the second receiving room; at least one water intake pipe and one water spraying pipe are set inside the vessel of the flowerpot. In addition, the water intake pipe stretches from the first receiving room to the second receiving room; the water is therefore filled into the second receiving room. A water drawing machine is set in the second receiving room and connected to the water spraying pipe; besides, the water drawing machine is controlled by the controller for drawing a fixed amount of water of the second receiving room at a fixed time, and the water is sprayed to the first receiving room by the water spraying pipe to prevent the pot plants from drying up.

The present invention is preferable by setting a third receiving room outside the vessel of the flowerpot to receive the controller. Furthermore, a pipe of the third receiving room can be stretched to the water drawing machine in the second receiving room, and electric wires of the water drawing machine can be connected to the control circuit through the pipe.

Setting an operating panel on a surface of the outer shell of the controller is a preferable case of the present invention, wherein a control circuit board is set in the controller, and the water drawing machine is controlled by the controlling circuit. Moreover, water can be sprayed for a fixed amount at a fixed-time through operating the operating panel of the controller.

The present invention prefers providing waning functions for indicating low power capacity and low water-level; thus, the water drawing machine does not idle and burn; the life-span of the flowerpot is also increased.

To provide a further understanding of the invention, the following detailed description illustrates embodiments and examples of the invention, this detailed description being provided only -for illustration of the invention.

### BRIEF DESCRIPTION OF THE DRAWINGS

FIG. 1 shows a three-dimensional exploded diagram of a first embodiment of the present invention;

FIG. 2 shows a three-dimensional exploded diagram of a second embodiment of the present invention;

FIG. 3 shows a circuit block diagram of a controller of the present invention; and

FIG. 4 shows a schematic diagram of an operating panel of the present invention.

### DETAILED DESCRIPTION OF PREFERRED EMBODIMENTS

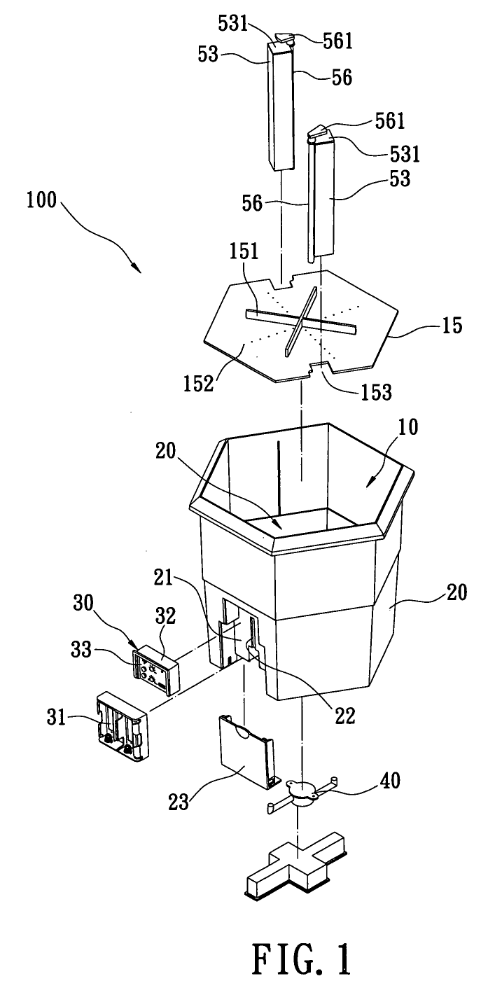

FIG. 1 shows a three-dimensional exploded diagram of a first embodiment of the present invention. An automatically watered flowerpot 100 of the present invention is a vessel with an upward opening; a stop board 15 is set inside the vessel and separates the vessel into upper and lower layers to form a first receiving room 10 and a second receiving room 20. Besides, the first receiving room 10 is designed for putting soil and planting pot plants and the second receiving room is designed for storing water. Further, a protruding part is set in the middle of the vessel of the flowerpot 100, and at least one protruding rib 151 is set on the stop board 15 to enforce sustenance of the stop board for supporting the soil. Meanwhile, a plurality of fine holes 152 are set on the stop board 15, and when the water in the soil of the first receiving room 10 is too much, the soil can penetrate into the second receiving room 20.

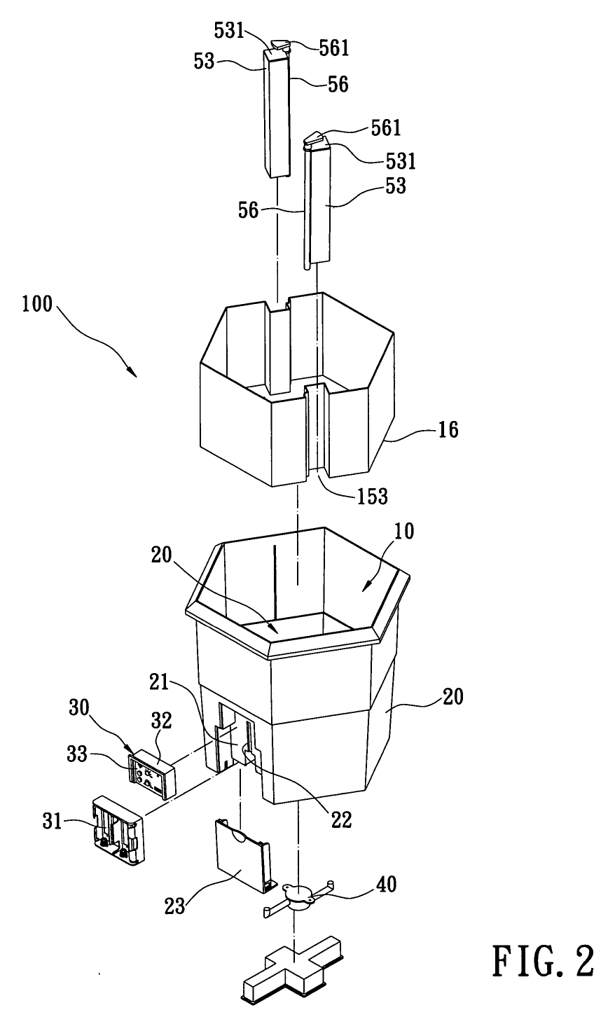

FIG. 2 shows a three-dimensional exploded diagram of a second embodiment of the present invention, the automatically watered flowerpot 100 is a vessel with an upward opening, an interior basin 16 is embedded above the interior part of the flowerpot 100 to form the first receiving room 10; the first receiving room 10 separates the interior part of the flowerpot 100 into upper and lower layers. Besides, the interior basin 16 is designed for putting soil and planting pot plants; the second receiving room 20 is formed below interior basin 16 and designed for storing water. Furthermore, a plurality of fine holes 152 is set on a bottom plate of the interior basin 16.

The flowerpot 100 further comprises at least a water intake pipe 53 and a water spraying pipe 56. However, a preferable embodiment of the present invention is with two water intake pipes 53 and two water spraying pipes 56. The water intake pipes 53 and the water spraying pipes 56 are combined together and stretched out of the upward opening of the flowerpot 100.

Further, the water intake pipe 53 stretches from the first receiving room 10 to the second receiving room 20, and the water is filled into the second receiving room 20 from the upper terminal of the water intake pipe; otherwise, the water spraying pipe 56 is stretched from the second receiving room 20 to the first receiving room 10. Furthermore, at least one concave part 153 is formed and circled around the stop board 15 or the interior basin 16, and the water intake pipe 53 and the water spraying pipe 56 are embedded into the concave part 153.

A moving stop board 531 is set on the upper terminal of the water intake pipe 53, and the moving stop board 531 can be lifted up and turned on for filling water into the second receiving room 20; the moving stop board 531 can also close the upper terminal of the water intake pipe 53.

Moreover, a sprinkle nozzle 561 is set on the upper terminal of the water spraying pipe 56, and a plurality of water spraying holes (not shown in the figure) is set on the sprinkle nozzle 561 for spraying water to the soil.

Moreover, the water spraying pipe 56 in the second receiving room 20 is connected to a water drawing machine 40 and the water drawing machine is preferable to be a water drawing pump. The water drawing machine 40 is connected to a controller 30 electrically and controlled by the controller 30. Therefore, the water drawing machine 40 draws the water from the second receiving room 20 for a fixed amount at a fixed time, and the water is sprayed to the soil and plants in the first receiving room 10 through the sprinkle-nozzle 561.

A third receiving room 21 is set outside the vessel of the flowerpot 100; furthermore, the third receiving room 21 is embedded in the external surface of the second receiving room 20. An external cover 23 is set to shelter the third receiving room 21. Besides, the third receiving room 21 receives the controller 30 and a battery box 31; a pipe 22 of the third receiving room 21 can be stretched to the water drawing machine 40 in the second receiving room 20, and electric wires of the water drawing machine 40 can be connected to the controller 30 through the pipe 22.

However, at least one battery can be put in the battery box 31, and the battery box 31 is connected to the controller 30 electrically to provide electric power for the controller 30 and the water drawing machine 40. Two sets of batteries can be put in the battery box 31 and one set of batteries are for the controller 30, and another set of batteries are for the water drawing machine 40. Meanwhile, the water drawing machine 40 uses more electric power than the controller 30; therefore, when the power of the batteries for the water drawing machine 40 is exhaust, the controller 30 is still working.

An outer shell 32 is set on the controller 30, and the controller 30 can be put in the third receiving room 21 by the outer shell 32. Otherwise, an operating panel 33 is set on a surface of the outer shell 32 and a control circuit board (not shown in the figure) is set inside the outer shell 32. Furthermore, a control circuit is set on the control circuit board, and the water drawing machine 40 is controlled by the controlling circuit through operating the operating panel 33 to spray water for a fixed amount at a fixed time.

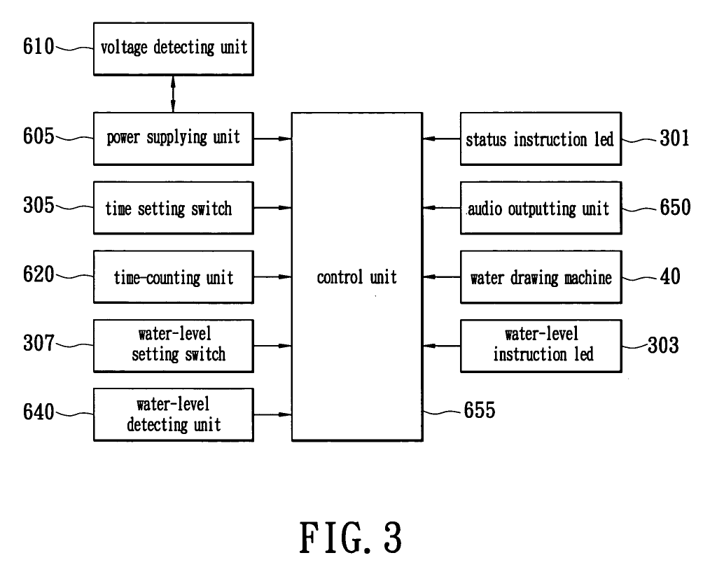

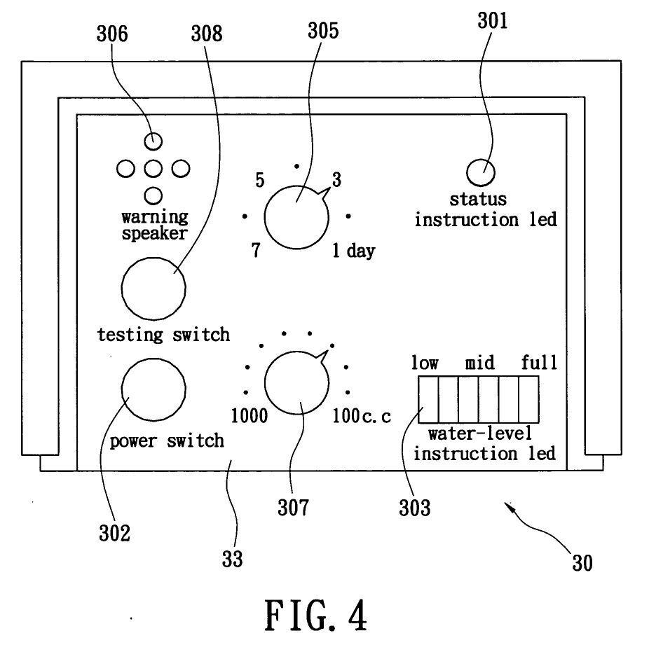

Please refer to FIG. 3, it shows a circuit block diagram of the controller of the present invention and FIG. 4 shows a schematic diagram of the operating panel of the present invention. Further, the operating panel 33 includes a status instruction led 301, a power switch 302, a water-level instruction led 303, a time setting switch 305, a warning speaker 306, a water-level setting switch 307, and a testing switch 308. A power supplying unit 605 is set in the control circuit of the controller 30 and connected to the power switch 302, and then the power supplying unit 605 is further connected to the battery box 31 to provide electric power for the controller 30 and the water drawing machine 40.

However, the power supplying unit 605 is further connected to a voltage detecting unit 610 to detect the electric power of the power supplying unit. When the electric power of the power supplying unit is low, a low electric power signal is outputted to a control unit 655, and then the control unit 655 controls the status instruction led 301 to give warning signals.

The control circuit further is connected to the control unit 655 and includes a time-counting unit 620 to provide a time-counting signal for the control unit 655. Otherwise, the control unit 655 is connected to a time setting unit (time setting switch 305), and the time setting unit can set a time range from one day to a week. Then, the time-counting unit 620 counts the preset time; when the preset time is due, the control unit 655 outputs a water drawing signal to the water drawing machine 40 for drawing the water from the second receiving room 20.

The control circuit further comprises a water-level controlling unit (water-level controlling switch 307) which is connected to the controlling unit 655. Therefore, the controlling unit 655 controls the time for drawing water by the water drawing machine 40 and water can be drew for the amount of 100 CC to 1000 CC. Identically, the controlling unit 655 fixes the amount of water drew by the water drawing machine 40.

Meanwhile, a water-level detecting unit 640 is connected to the controlling unit 655 electrically to detect the water-level in the second receiving room 20. It is preferable that water-level detecting unit includes a plurality of electric conductors (not shown), and stretches to the second receiving room 20. Further, owing to the conductivity of water, the water-level detecting unit is viewed as a sensor for detecting the water-level. Besides, the controlling unit 655 outputs a water-level detecting signal to the water-lever instruction led 303 for displaying the status of water-level.

When the water-level in the second receiving room is low, a low water-level signal is outputted to the controlling unit 655 by the water-level detecting unit 640. Then, the controlling unit 655 controls the status instructions led to give a warning light. The status instruction led 301 is preferable to be a LED with two colors, and the led glitters with a green light every five seconds to represent a normal status of the flowerpot 100.

On the contrary, the LED glitters with a red light every second to represent a low water-level and low power status of the flowerpot 100. Further, an audio outputting unit 650 of the warning speaker 306 is set on the operating panel 33, like a buzzer, to give a warning voice and remind users to change batteries and supply water for the second receiving room 20.

Meanwhile, the controlling unit 655 can stop the water drawing machine 40 drawing water under the low water-level and low power status; thus, the water drawing machine 40 is not idle running to burn.

Especially, a testing switch 308 (TEST) is set on the operating panel 33 for users to reset time counted by the time-counting unit 620. Hence, the flowerpot 100 has more complete functions and convenience.

There has thus been described a new, novel and heretofore unobvious flowerpot which eliminates the aforesaid problem in the prior art. Furthermore, those skilled in the art will readily appreciate that the above description is only illustrative of specific embodiments and examples of the invention. The invention should therefore cover various modifications and variations made to the herein-described structure and operations of the invention, provided the fall within the scope of the invention as defined in the following appended claims.

What is claimed is:

1. An automatically watered flowerpot, comprising:
a vessel of the flowerpot with an upward opening;
a stop board set in the vessel of the flowerpot to form a first receiving room and a second receiving room;
at least one water intake pipe set inside the vessel of the flowerpot, and the water intake pipe stretched from the first receiving room to the second receiving room;
at least a water spraying pipe set inside the vessel of the flowerpot, and the water spraying pipe stretched from the second receiving room to the first receiving room; and
a water drawing machine set at the bottom of the second receiving room, and a water outlet connected to the water spraying pipe;
wherein potted plants and soils are put in the first receiving room and water is stored in the second receiving room; the water is filled into the second receiving room form the top of the water intake pipe; the water outlet is connected to a controller electrically and the water outlet is controlled by the controller; the water in the second receiving room is drew for a fixed amount at a fixed time under the control of the controller and the water is sprayed to the first receiving room by the water spraying pipe.

2. The automatically watered flowerpot as in claim 1, wherein a protruding part is set in the middle of the vessel of the flowerpot to keep the stop board in the middle of the vessel horizontally.

3. The automatically watered flowerpot as in claim 1, wherein the stop board is an inner container with an upward opening.

4. The automatically watered flowerpot as in claim 1, wherein at least one protruding rib is set on the stop board to enforce sustenance of the stop board.

5. The automatically watered flowerpot as in claim 1, wherein a plurality of fine holes are set on the stop board, and water in the first receiving room can penetrate into the second receiving room.

6. The automatically watered flowerpot as in claim 1, wherein at least one concave part is formed and circled around the stop board; the water intake pipe and the water spraying pipe are embedded into the concave part.

7. The automatically watered flowerpot as in claim 1, wherein the water intake pipe and the water spraying pipe are combined together.

8. The automatically watered flowerpot as in claim 1, wherein a moving stop board is set on the upper terminal of the water intake pipe, and the moving stop board can be lifted up and turned on for filling water into the second receiving room; the moving stop board can also close the upper terminal of the water intake pipe.

9. The automatically watered flowerpot as in claim 1, wherein a sprinkle nozzle is set on the upper terminal of the water spraying pipe and a plurality of water spraying holes are set on the sprinkle nozzle for spraying water.

10. The automatically watered flowerpot as in claim 1, wherein the water intake pipe and the water spraying pipe are stretched outward from the upper opening of the vessel of the flowerpot.

11. The automatically watered flowerpot as in claim 1, wherein the water drawing machine is a water drawing pump.

12. The automatically watered flowerpot as in claim 1, wherein a third receiving room is set outside the vessel of the flowerpot to receive the controller; a pipe of the third receiving room can be stretched to the water drawing machine in the second receiving room, and electric wires of the water drawing machine can be connected to the control circuit through the pipe.

13. The automatically watered flowerpot as in claim 12, wherein the third receiving room is embedded outside the second receiving room.

14. The automatically watered flowerpot as in claim 12, wherein a battery box is set inside the third receiving room and at least one battery can be put in; the battery box is connected to the controller electrically to provide electric power for the controller and the water drawing machine.

15. The automatically watered flowerpot as in claim 14, wherein two sets of batteries are in the battery box; batteries in one set are for the controller, and batteries in another set are for the water drawing machine.

16. The automatically watered flowerpot as in claim 12, wherein an outer cover is set on the external surface of the third receiving room.

17. The automatically watered flowerpot as in claim 1, wherein the controller further comprises:
an outer shell set inside the third receiving room of the external surface of the vessel;
an operating panel set on a surface of the outer shell;
a control circuit board buried in the outer shell;
wherein a control circuit is set on the control circuit board, and the water drawing machine is controlled by the controlling circuit through the operating panel to spray water for a fixed amount at a fixed time.

18. The automatically watered flowerpot as in claim 17, wherein the operating panel includes: a power switch, a power capacity instruction led, a water-level instruction led, a time setting switch, a water-level setting switch, a testing switch, and a warning speaker.

19. The automatically watered flowerpot as in claim 17, wherein the controlling circuit comprises:
a power supplying unit providing a electric power;
a time-counting unit providing a time counting signal;
a time setting unit presetting a time for watering;
a water-level controlling unit to control the time for drawing the water by the water drawing machine;
a controlling unit connected to the power supplying unit, the time-counting unit; the time setting unit and the water-level controlling unit;
wherein the water drawing machine is controlled by the time setting unit presetting a watering time and the water-level controlling unit regulating the water drawing time.

20. The automatically watered flowerpot as in claim 19, wherein a range of time set by the time setting unit is set from a day to a week.

21. The automatically watered flowerpot as in claim 19, wherein the power supplying unit is connected to a voltage detecting unit to detect the electric power of the power supplying unit; and when the electric power of the power supplying unit is low, a low electric power signal is outputted.

22. The automatically watered flowerpot as in claim 21, wherein the voltage detecting unit is connected to a displaying led for indicating the low electric power status.

23. The automatically watered flowerpot as in claim 19, wherein further comprises:
a water-level detecting unit connected to the controlling unit electrically to detect the water-level in the second receiving room;
a displaying unit connected to the controlling unit electrically and displaying a light signal for low water-level; and
an audio outputting unit connected to the controlling unit electrically and outputting a warning voice for low water-level.

24. The automatically watered flowerpot as in claim 23, wherein the water-level detecting unit includes a plurality of electric conductors, and stretches to the second receiving room; by the characteristic of the conductivity of water, the water-level detecting unit is viewed as a sensor.

25. The automatically watered flowerpot as in claim 23, wherein the controlling unit stops the water drawing machine drawing water by detecting a low water-level in the second receiving room.

26. The automatically watered flowerpot as in claim 23, wherein the displaying unit is a LED display and twinkles one or two times per second for low voltage and low water-level.

27. The automatically watered flowerpot as in claim 26, wherein the LED display twinkles one time every five seconds for normal voltage and normal water-level.

28. The automatically watered flowerpot as in claim 23, wherein the audio outputting unit is a buzzer.
